(19) United States
(12) Patent Application Publication
(10) Pub. No.: US 2023/0312263 A1
(43) Pub. Date: Oct. 5, 2023

(54) SYSTEM AND METHOD FOR MATERIAL CONVEYOR CONTAINER WEAR MONITORING

(71) Applicant: BRAIME GROUP PLC, Leeds (GB)

(72) Inventor: Paul Dennis, Queensland (AU)

(21) Appl. No.: 18/023,377

(22) PCT Filed: Aug. 18, 2021
(86) PCT No.: PCT/AU2021/050906

§ 371 Date: Feb. 26, 2023

(30) Foreign Application Priority Data
Aug. 26, 2020 (AU) 2020223683

(51) Int. Cl. B65G 43/02; B65G 17/12; B65G 17/36

(52) U.S. Cl. CPC B65G 43/02; B65G 17/126; B65G 17/36; B65G 2203/0275; B65G 2207/48; B65G 2203/046

(57) ABSTRACT

A system and method for material conveyor bucket wear monitoring. A material conveyor system elevator bucket comprising a back wall, opposed sidewalls, a bottom wall curving upward into a front wall spaced from the back wall, a lip, a volume of space, and at least one wear monitor affixed to the elevator bucket, wherein the wear monitor transmits information using electromagnetic fields.

### BACKGROUND

In the art of elevator-type material conveyor systems, containers or so-called “buckets” are supported spaced-apart on an endless belt or chain for moving particulate material substantially vertically at least between a first elevation and a second higher elevation. A common application for elevator-type conveyor systems and the buckets associated therewith is for grain elevators as well as other applications wherein granular or particulate solid materials or material mixtures are conveyed by loading the buckets with conveyance material as the buckets move along the path of the endless belt or chain support structure. As the buckets go over the top of the conveyor, they tip over and empty, ready for more material on their way up again.

Material can fill the bucket by moving along a conveyor belt, falling off the end of the conveyor belt and into the bucket through an opening, typically located in the top of the bucket. The material that fills the bucket is abrasive and wears away the front edge lip and a forward portion of side walls of the bucket as it falls from the conveyor belt into the bucket. Also, not all material that falls off the conveyor belt is captured by the bucket. The buckets can be positioned to pick up the materials sitting on the ground that did not fall into the bucket. The materials scrape against the front edge lip and a forward portion of side walls of the bucket as the bucket picks them up from the ground and wear away the portion of the bucket that contacts the materials.

The buckets can be made from many types of materials, and material selection is typically based on cost, environmental factors, and the particular type of material being conveyed by the bucket. Elevator buckets are made of one material, and the material typically comprises polymers such as polyethylene, particularly high-density polyethylene (HDPE), polyurethane, and nylon.

A longstanding problem with elevator buckets relates to excessive wear on the front edge lip and a forward portion of side walls of the buckets incurred as the flow of material being conveyed filling the buckets while they pass along their path of movement. Premature failure of the front edge or lip can result in loss of bucket capacity which adversely affects material transport operations. Bucket systems need to be visually inspected to determine if the buckets are in good repair or need to be replaced. This requires shutting down the elevator bucket system, opening the casing, and having a person visually inspect each bucket for damage. The loss of usability of the bucket system results in loss of efficiency, capacity, and profitability for the user.

Accordingly, there has been a need to develop a material elevator bucket system that can be monitored for wear damage without needing to shut down the system to visually inspect the parts, such as the buckets.

### SUMMARY

The present disclosure provides material conveyor container system, particularly a material conveyor container system comprising at least one wear monitor affixed to an elevator bucket.

In one embodiment, a material conveyor system container can comprise an elevator bucket having a back wall, opposed sidewalls, a bottom wall curving upward into a front wall spaced from the back wall, a lip, a volume of space, and at least one wear monitor, wherein the wear monitor transmits information about the elevator bucket through electromagnetic fields.

In one embodiment, the material conveyor system container further comprises a wear band affixed to the lip.

In one embodiment, the at least one wear monitor is a RFID tag.

In one embodiment, the at least one wear monitor is embedded into the lip of the elevator bucket.

In one embodiment, the material conveyor system container, the at least one wear monitor is embedded into the wear band.

In one embodiment, the material conveyor system container comprises at least two wear monitors.

In one embodiment, the wear band is removably affixed to the lip of the bucket.

In one embodiment, a material conveyor system container comprises a single uniform body formed of two polymers. The container comprises a back wall, a pair of opposed sidewalls, a planar bottom wall forming a front wall, a lip made of a first polymer, and at least one wear monitor, wherein the wear monitor transmits information using electromagnetic fields, and a wear band made of a second polymer and affixed to the lip. The wear band extending entirely across a top portion of the front wall and arcuate corner parts. The wear band can extend across a portion of a top edge of the pair of opposed sidewalls, wherein the second polymer is overmolded onto the first polymer.

In one embodiment, the at least one wear monitor is a passive wear monitor.

In one embodiment, the passive wear monitor is a RFID tag.

In one embodiment, the second polymer is a highly abrasion resistant material.

In one embodiment, a method of manufacturing a material conveyor system container comprises forming an elevator bucket comprising a lip, a back wall, opposed sidewalls; integral corner parts, and a front wall, wherein the front wall is joined to the back wall forming an open top, wherein the elevator bucket is made of a material comprising polyethylene, and affixing at least one wear monitor the elevator bucket, wherein the wear monitor transmits information using electromagnetic fields.

In one embodiment, the wear band is formed, wherein the wear band is made of an abrasion resistant material, and the wear band is affixed to the lip of the bucket part, wherein the wear band extends entirely across a top portion of the front wall, arcuate corner parts, and extends across a portion of opposed sidewalls extending from the front wall towards the back wall.

In one embodiment, at least one wear monitor is embedded into the elevator bucket.

In one embodiment, the at least one wear monitor is embedded in the lip or the wear band of the elevator bucket.

In one embodiment, the wear band is removably affixed to the elevator bucket with fasteners, adhesives, tongue and groove system, or a combination thereof.

In one embodiment, the wear band is attached to the elevator bucket by overmolding the wear band onto the lip of the elevator bucket.

In one embodiment, at least two wear monitors are embedded into the elevator bucket.

In one embodiment, the wear monitor system is capable of time stamping when it receives a signal from at least one wear monitor.

In one embodiment, the wear monitor system is capable of providing data that can be used to calculate the speed of the material containers and distance between the material containers.

In at least one embodiment, the wear monitor system is capable of detecting if a material container has fallen off and/or disengaged from the material conveyor system.

Those skilled in the art will further appreciate the above-mentioned advantages and superior features of the invention together with other important aspects thereof up reading the detailed description which follows in conjunction with the drawings.

### BRIEF DESCRIPTION OF THE DRAWINGS

FIG. 1 illustrates a top perspective view of one embodiment of a material conveyor system container comprising a wear monitor;

FIG. 2 illustrates a bottom perspective view of one embodiment of a material conveyor system container wear band comprising a wear monitor;

FIG. 3 illustrates a side plan view of one embodiment of a material conveyor container comprising a wear band;

FIG. 4 illustrates a front plan view of one embodiment of a material conveyor system container comprising a wear band and a wear monitor;

FIG. 5 illustrates a front plan view of one embodiment of a material conveyor system container comprising a wear band and more than one wear monitor;

FIG. 6 illustrates a bottom perspective view of one embodiment of a material conveyor system container wear band comprising more than one wear monitor;

FIG. 7 illustrates a top perspective view of one embodiment of a material conveyor system container without a wear band comprising through holes for attaching a removable wear band and more than one wear monitor; and

FIG. 8 illustrates a top perspective view of one embodiment of a material conveyor system container with a removably attached wear band and more than one wear monitor.

### DESCRIPTION OF THE PREFERRED EMBODIMENTS

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

Accordingly, the detailed discussion herein of one or more embodiments is not intended, nor is it to be construed, to limit the boundaries of the descriptions but rather as defined by the claims and equivalents thereof. Therefore, embodiments not specifically addressed herein, such as adaptations, variations, modifications, and equivalent arrangements, should be and are considered to be implicitly disclosed by the illustrative embodiments and claims set forth herein and therefore fall within the scope of the present invention.

Further, it should be understood that, although steps of various claimed methods may be shown and described as being in a sequence or temporal order, the steps of any such method are not limited to being carried out in any particular sequence or order, absent an indication otherwise. That is, the claimed method steps are considered capable of being carried out in any sequential combination or permutation order while still falling within the scope of the present invention.

Additionally, it is important to note that each term used herein refers to that which a person skilled in the relevant art would understand such term to mean, based on the contextual use of such term herein. To the extent that the meaning of a term used herein, as understood by the person skilled in the relevant art based on the contextual use of such term, differs in any way from any particular dictionary definition of such term, it is intended that the meaning of the term as understood by the person skilled in the relevant art should prevail.

Furthermore, a person skilled in the art of reading claimed inventions should understand that “a” and “an” each generally denotes “at least one,” but does not exclude a plurality unless the contextual use dictates otherwise. Also, the term “or” denotes “at least one of the items,” but does not exclude a plurality of items of the list.

In the description which follows, like parts are marked throughout the specification and drawings with the same reference numerals, respectively. The drawing figures may not necessarily be to scale and certain features may be shown in somewhat schematic form in the interest of clarity and conciseness.

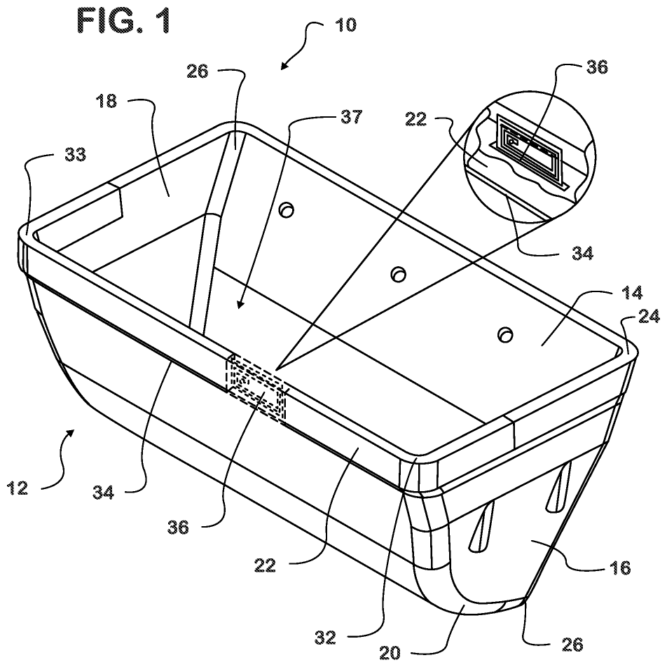

Referring to FIG. 1, there is illustrated one embodiment of a material conveyor container system with at least one wear monitor and generally designated by the numeral 10. An elevator bucket 12 is characterized by a back wall 14, opposed sidewalls 16 and 18 and a combined curvilinear bottom and front wall 20 delimited by a wear band 22. The back wall 14 and opposed sidewalls 16 and 18 are joined by arcuate corner parts 24 and 26, and the back wall 14 is joined to the combined bottom and front wall 20 by lower integral corner parts 28 and 30 (30 not shown). The combined bottom and front wall 20 is joined to opposed sidewalls 16 and 18 by integral corner parts 32 and 33.

The wear band 22 comprises a lip 34. The lip 34 extends the entire length of the combined bottom and front wall 20 between integral corner parts 32 and 33, the entire length of the integral corner parts 32 and 33, and a contiguous portion of the opposed sidewalls 16 and 18. The wear band 22 can extend onto the opposed sidewalls 16 and 18 in any length that would protect a lip 34 of the opposed sidewalls 16 and 18 from wear during use of the elevator bucket 12.

The wear band 22 can be overmolded onto the elevator bucket 12 to form an elevator bucket 12 that is either a single continuous bucket or the wear band 22 can be injection molded and combined with the rest of the bucket by other means known in the art. By “overmolding” is generally meant an injection molding process whereby one part is molded on top of another part. A previously molded first part is inserted in a mold cavity, and the second part is molded over the first in an injection molding process to effectively create the final integrated assembly.

Preferred methods for molding the overmolded articles include, but are not limited to, injection molding, casting, extruding, compression molding, sintering, machining, or combinations thereof, although in the preferred embodiment, Injection molding is preferred.

In one embodiment of the present disclosure, the elevator bucket 12 without the wear band 22 would be first injection molded part and the wear band 22 would be the second injection molded part. The wear band 22 would be molded over the elevator bucket 12, which would not comprise the wear band 22 until the wear band 22 is molded over it.

The wear band 22 can also be welded onto the elevator bucket 12 through, for instance, the process of ultrasonic welding.

The wear band 22 can be removably fixed or attached to the elevator bucket 12 by means known in the art of fastening or attaching two objects together, such as through interlocking features molded onto the inner channel in the wear band and the lip 34, such as a tongue and groove configuration, where the wear band comprises a protrusion and the lip 34 comprises a corresponding slot for the protrusion to lock into, or vice versa.

The angle of the lip 34 of the elevator bucket assists with the efficiency of the elevator material conveyor container system (not shown). Lip 34 can control the start and stop of the centrifugal discharge of the granular material inside of the elevator bucket 12 as the elevator bucket 12 runs over a top pulley of the elevator material conveyor container system (not shown). A point of discharge is set by distance of the lip 34 from the center line a pulley of the elevator material conveyor container system, and combined with the belts speed and the angle of the front radius, determines the point at which the granular material starts to be discharged from a volume of space 37 inside the elevator bucket 12.

At least one wear monitor 36 can be affixed to the elevator bucket 12. The at least one wear monitor can be affixed to any portion of the elevator bucket 12 that wears away. The at least one wear monitor 36 can be affixed to an elevator bucket 12 that does not comprise a wear band. The at least one wear monitor 36 can be affixed to wear band 22 or lip 34 at any point along the wear band 22 or lip 34. The at least one wear monitor 36 can be embedded into the wear band 22 or lip 34, or both. The wear monitor 36 can be affixed to the wear band 22 or the lip 34 by cold welding, or it can be affixed to a notch routed into the wear band 22 or lip 34 that is large enough to accept the wear monitor 36. Once the wear monitor 36 is placed into the notch, the notch can be coated with material to seal in the wear monitor 36. The coated material can be made level with the outer edge of the wear band 22 or lip 34, so it does not protrude past the edge of the wear band 22 or lip 34.

The notch may be made by a plunge router to create a cavity on the lip 34, wear band 22, front wall 20 and/or back wall 14 of elevator bucket 12. The cavity will house the wear monitor 36, and once the wear monitor 36 is placed in the cavity, the cavity can be sealed using a hand held hot air extruder/welder to seal it within the wall of the bucket. The wear monitor 36 may also be embedded into the lip 34, wear band 22, front wall 20 and/or back wall 14 using a manual and/or thermosetting (epoxy) method of embedding.

The wear monitor can be a wireless, non-contact tag or chip that uses electromagnetic fields to transmit to, and receive signals from, a wear monitor reader (not shown), such as a radio frequency identification tag. The wear monitor 36 can be an active monitor and require a battery, or a passive monitor and not require a battery.

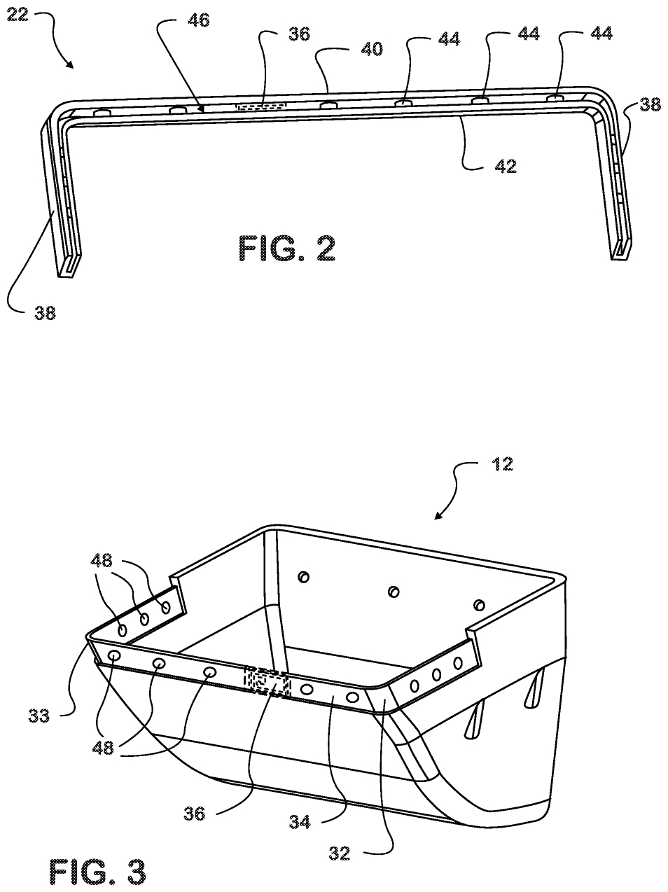

Turning to FIG. 2, one embodiment of the wear band 22 is illustrated in a bottom perspective view. The wear band 22 can comprise two sides 38, front 40, back 42, optional wear band through bores 44, and slot 46. The wear band 22 can be made as a single piece or it can be made in multiple pieces, and the pieces can be adhered together with fasteners, adhesives, frictional forces, tongue and groove system, or the like. The slot 46 can run the entire length of the wear band 22 and will accept lip 34 (see FIG. 3) when the wear band 22 is attached to the elevator bucket 12. The wear band 22 can be permanently attached to the elevator bucket 12, or it can be removably attached to the elevator bucket 12. A removably attached wear band 22 can be replaced if the abrasive granular material damages the wear band 22 as it passes over the wear band 22 when filling the elevator bucket 12 or when emptying it.

The at least one wear monitor 36 can be attached to the wear band 22 inside the slot 44.

Turning to FIG. 3, one embodiment of the elevator bucket 12 is illustrated in a perspective view for exemplary purposes. The lip 34 of the elevator bucket 12 is exposed, and comprises optional lip through bores 48. The wear band 22 (not shown) is placed over the lip 34, the lip 34 enters the slot 46 (see FIG. 2) and can be removably attached to the lip 34 with a tongue and groove system, an adhesive, with frictional forces, or the like. When the wear band 20 is placed over the lip 34, the lip 34 enters the slot 46 (see FIG. 2) and the optional wear band through bores 44 (see FIG. 2) align with the optional lip through bores 48. If a fastener is used to removably attach the wear band 22 to the elevator bucket 12, the optional wear band through bores 44 and the optional lip through bores 48 accept the fastener.

At least one wear monitor 36 can be attached to the lip 34. The at least one wear monitor can be attached to the outside or inside of the lip 34. The at least one wear monitor can be attached to the wear band 22 (see FIG. 2) and to the lip 34, if desired. The at least one wear monitor 36 can be attached to the inside of the lip 34, outside of the lip 34, and in the slot 46, if desired.

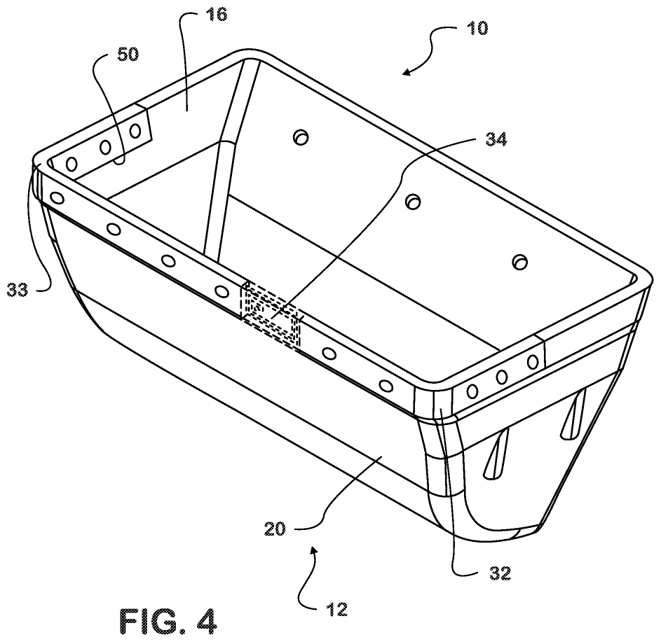

Turning to FIG. 4, one embodiment of an elevator bucket 12 for a material conveyor container with at least one wear monitor 10 is illustrated in a top perspective view for exemplary purposes. The wear band 22 is removably attached to the elevator bucket 12. The joint 50 is created when the wear band 22 is attached to the elevator bucket 12. The joint 50 is on the internal face of elevator bucket 12, and the internal face comprises the opposed sidewalls 16 and front wall 20. The granular material is discharged out of the elevator bucket 12 by tipping the elevator bucket 10 to pour the granular material onto a conveyor belt or into another container. The discharge of the granular material out of the elevator bucket 12 should be uninterrupted and any bumps, ripples or corrugations on the inside face of the elevator bucket 12. Any bumps, ripples, or corrugations below the joint 50 will disrupt the discharge of the granular material out of the elevator bucket 12 and prevent an effective discharge of the material. The joint 50 can be aligned with the internal face of the elevator bucket 12 to create one smooth surface so the joint 50 will not interrupt the flow of granular material out of the elevator bucket 12. At least one wear monitor can be embedded in the wear band 22, lip 34, or both.

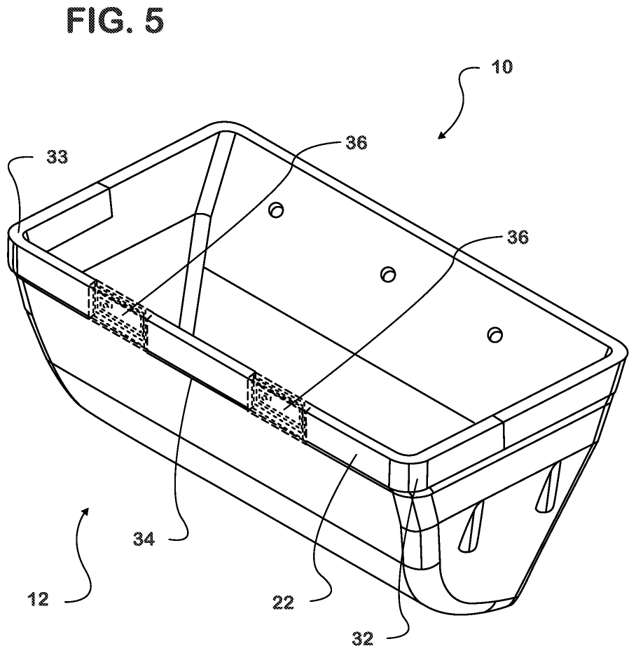

Turning to FIG. 5, a front plan view of one embodiment of a material conveyor container system with at least one wear monitor 10, similar to FIG. 1, comprising a wear band 22 and more than one wear monitor 36 is illustrated. The more than one wear monitor 36 can be attached to the wear band 22, the lip 34, or both. If at least two wear monitors 36 are utilized, each can be located on the wear band 22 of the elevator bucket 12, one being placed near each of the integral corner parts 32 and 33, they can be located a centrally along the wear band 22 in parallel and aligned side by side, or they can be stacked, one on top of the other (not shown), with or without a layer of wear band 22 material in between each of the wear monitors 36.

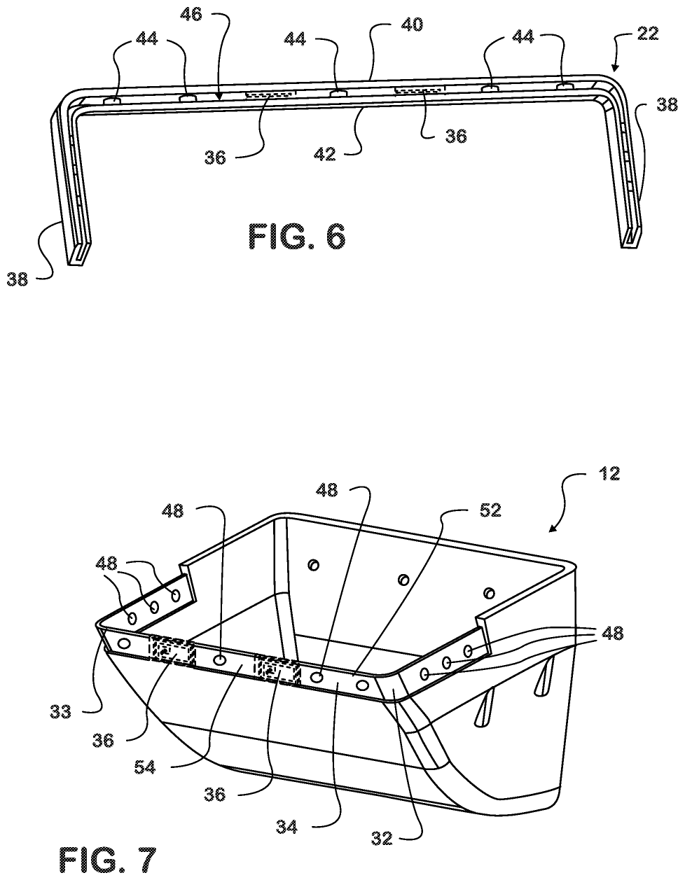

Turning to FIG. 6, a bottom perspective view of one embodiment of a material conveyor system wear band 22, similar to FIG. 2, comprising more than one wear monitor 22 can be seen. The wear band 22 can comprise two sides 38, front 40, back 42, optional wear band through bores 44, and slot 46. The wear band 22 can be made as a single piece or it can be made in multiple pieces, and the pieces can be adhered together with fasteners, adhesives, frictional forces, tongue and groove system, or the like. The slot 46 can run the entire length of the wear band 22 and will accept lip 34 (see FIG. 3) when the wear band 22 is attached to the elevator bucket 12. The wear band 22 can be permanently attached to the elevator bucket 12, or it can be removably attached to the elevator bucket 12. A removably attached wear band 22 can be replaced if the abrasive granular material damages the wear band 22 as it passes over the wear band 22 when filling the elevator bucket 12 or when emptying it.

The at least one wear monitor 36 can be attached to the wear band 22 inside the slot 44. If at least two wear monitors 36 are utilized, each can be located on the wear band 22 of the elevator bucket 12, one being placed near each of the integral corner parts 32 and 33 on the front 40 or the back 42, the wear monitors 36 can be located a centrally along the wear band 22 in parallel and aligned side by side on the front 40 or the back 42, or one wear monitor can be attached to the inside of the front 40 and one wear monitor 36 can be attached to the inside of the back 42.

Turning to FIG. 7, a top perspective view of one embodiment of an elevator bucket 12 for a material conveyor bucket wear monitoring system 10 without a wear band 22 comprising through holes 48 for attaching a removable wear band 22 and more than one wear monitor 36 to the lip 34, similar to FIG. 3. Lip 34 comprises an inner face 52 and an outer face 54. The more than one wear monitor 36 can be attached to the inner face 52 or outer face 54, or both. If at least two wear monitors 36 are utilized, each can be located on the inner face 52, one being placed near each of the integral corner parts 32 and 33, can be located a centrally along the inner face 52 in parallel and aligned side by side, or they can be stacked, one on the inner face 52 and one on the outer face 54. If at least two wear monitors 36 are utilized, each can be located on the outer face 54, one being placed near each of the integral corner parts 32 and 33, or can be located a centrally along the outer face 54 in parallel and aligned side by side. This disclosure is not intended to be limited by the position of the at least one wear monitor 36 on the elevator bucket 12.

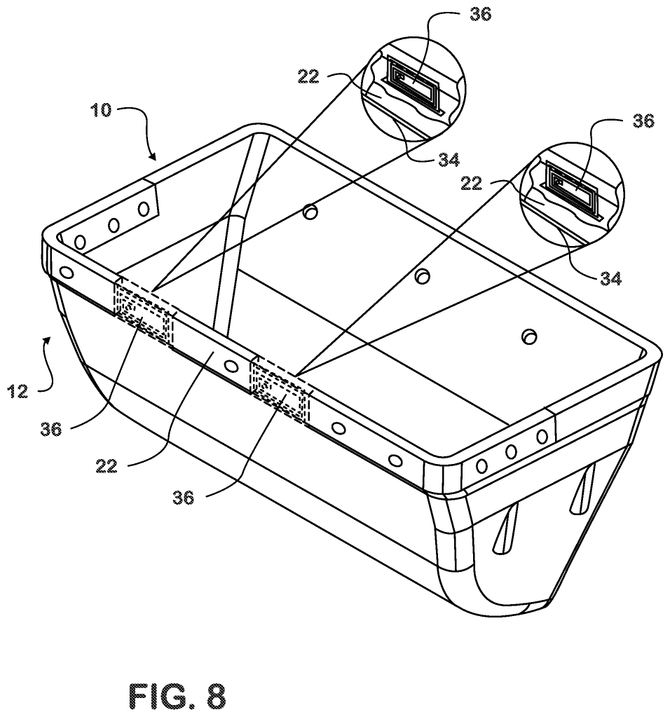

Turning to FIG. 8, a top perspective view of one embodiment of an elevator bucket 12 of a material conveyor container system with at least one wear monitor 10 with a removably attached wear band 22 and more than one wear monitor 36 thereon, similar to FIG. 1 and FIG. 5. If at least two wear monitors 36 are utilized, each can be located on the wear band 22 of the elevator bucket 12, one being placed near each of the integral corner parts 32 and 33, they can be located a centrally along the wear band 22 in parallel and aligned side by side, or they can be stacked, one on top of the other (not shown), with or without a layer of wear band 22 material in between each of the wear monitors 36.

Referring to FIGS. 1, 2, 3, 4, 5, 6, 7, and 8, the wear band 22 protects the lip 34 from wearing including that portion at its juncture with the top edges 32 and 33. As lip 34 wears away, the capacity of the elevator bucket 12 will become less as the combined bottom and front wall 20 wears away toward its juncture with front wall 20, thus reducing the volume of the space 37, FIG. 1, which is the working volume of the elevator bucket 12.

At least one wear monitor 36, which can be an RFID tag or chip, is affixed to the elevator bucket 12, along a portion of the elevator bucket that wears away from use. The wear monitor 36 is in communication with a wear monitor reader, which can be an RFID reader (not shown). The wear monitor reader can be located on a structure (e.g., a wall of an elevator bucket shaft or housing) that the elevator bucket 12 passes while in use. The wear monitor reader communicates with the at least one wear monitor 36. If the wear monitor 36 is not detected by the wear monitor reader (not shown), an alarm can be triggered or an alert can be sent to a computer or mobile device indicating the elevator bucket 12 needs repair.

The wear monitor 36 can be associated with information about the elevator bucket 12 that it is attached too and the information can be accessed via a wired or wireless network. The information can be stored in a searchable database and include a serial number, an origin, a date of manufacture, the material composition of the elevator bucket 12, a last service or repair or replace date, or any other information that would be beneficial to know about the elevator bucket 12. This stored information can enable a user to quickly determine which elevator bucket 12 needs repair in the material conveyor system and reduce down time of the material conveyor system.

In some embodiments, the wear monitor system 10 is capable of time stamping and/or date stamping each reading received at the wear monitor reader (not shown) from the wear monitor 36. The time stamp and/or date stamp information can be used to measure and/or determine the distance between the wear monitor 36 affixed to one elevator bucket 12 and the wear monitor 36 affixed to another elevator bucket 12. The distance measurements can be used to determine if there is slag or stretch in a belt connecting each elevator bucket 12 in a material conveyor system to the belt in the material conveyor system. The distance measurements may also be used to determine whether the belt is aligned properly or has become misaligned. The distance measurement and time stamp information can be used to determine the speed of at least one elevator bucket 12, and the wear monitor system 10 can be capable of reporting this information to a computer or mobile device. The optimal or preferred distance and/or time differential between reading a first wear monitor 12 and a second wear monitor 12 can be prerecorded or stored in a database in a computer and compared to the calculated or determined distance measurement obtained by analyzing information received from the wear monitor system 10. The prerecorded or stored preferred time differential can be an exact time measurement or can be a range of time measurements.

In some embodiments, a controller or computer comprising a software application or mobile device receives information from the wear monitor reader (not shown) about the at least one wear monitor 36 not detected. The controller then provides diagnostic information to a user. This information can include when the elevator bucket 12 was installed, how many hours the elevator bucket 12 has been in operation, where the wear monitor 36 was attached to the elevator bucket 12, etc.

In some embodiments, the at least one wear monitor 36, the signal strength of the at least one wear monitor 36 is high. The wear monitor reader (not shown) may detect a decrease in signal strength and provide an alert that the at least one wear monitor 36 has been damaged.

The at least one wear monitor 36 is encased in the elevator bucket 12 material and rigidly affixed to the elevator bucket 12. The material that will be used to make the elevator bucket 12 can be placed in a mould, along with the at least one wear monitor and optional additional circuitry. A casing may be placed around the at least one wear monitor 36 to protect it from the heat and pressure during the forming of the elevator bucket 12. In some embodiments, a tuning circuit in the at least one wear monitor 36 tunes the wear monitor 36 once the wear monitor 36 is activated in the elevator bucket 12.

Fabrication of the elevator bucket 12 and related, nominally dimensioned buckets, as described herein, may be created with conventional polymer molding and overmolding methods, such as by injection molding, to provide a rugged, integral one-piece bucket with increased service life heretofore unappreciated in the art.

Other methods of attaching the abrasion resistant material (wear band 23) to the non-wear band portions of the elevator bucket 12 comprise with an interlocking system, such as a tongue and groove system, fasteners, adhesive, or a combination thereof. The wear band 22 can be permanently fixed to the elevator bucket 12 or it can be removably fixed to the elevator bucket 12, which would allow the wear band 22 to be replaced if it is worn away by the abrasive materials that are loaded into the elevator bucket 12.

As the wear band 22 wears away, the wear monitor 36 becomes exposed and can be damaged by the materials filling the elevator bucket 12. The materials filling the elevator bucket 12 can also remove the wear monitor 36 from the wear band 22 or lip 34. A wear monitor reader (not shown) is fixed in place and located within a range of the wear monitor to receive and send signals to the wear monitor

Although preferred embodiments of the invention have been described in detail herein, those skilled in the art will recognize that various substitutions and modifications may be made without departing from the scope and spirit of the appended claims.

1. A material conveyor system container comprising:
an elevator bucket having a back wall, opposed sidewalls, a bottom wall curving upward into a front wall spaced from the back wall, a lip, a volume of space, and at least one wear monitor affixed to the elevator bucket, wherein the wear monitor transmits information about the elevator bucket through electromagnetic fields.

2. The material conveyor system container of claim 1, wherein the elevator bucket further comprises a wear band affixed to the lip.

3. The material conveyor system container of claim 1, wherein the at least one wear monitor is a RFID tag.

4. The material conveyor system container of claim 1, wherein the at least one wear monitor is embedded into the lip.

5. The material conveyor system container of claim 2, wherein the at least one wear monitor is embedded into the wear band.

6. The material conveyor system container of claim 1, wherein the information about the elevator bucket comprises time stamp information.

7. The material conveyor system container of claim 2, wherein the information about the bucket comprises date stamp information.

8. The material conveyor system container of claim 5, further comprising at least two wear monitors.

9. A material conveyor system container, comprising:
a single uniform body formed of two polymers, comprising:
a back wall, a pair of opposed sidewalls, a planar bottom wall forming a front wall, a lip made of a first polymer, and at least one wear monitor, wherein the wear monitor transmits information using electromagnetic fields; and
a wear band made of a second polymer and affixed to the lip;
the wear band extending entirely across a top portion of the front wall and arcuate corner parts;
the wear band extending across a portion of a top edge of the pair of opposed sidewalls; and
wherein the second polymer is overmolded onto the first polymer.

10. The material conveyor system container of claim 9, wherein the at least one wear monitor is a passive wear monitor.

11. The material conveyor system container of claim 10, wherein the passive wear monitor is a RFID tag.

12. The material conveyor system container of claim 9, wherein the information comprises a time stamp.

13. The material conveyor system container of claim 9, wherein the at least one wear monitor is affixed to the wear band.

14. A method of manufacturing a material conveyor system container, comprising:
forming an elevator bucket comprising a lip, a back wall, opposed sidewalls; integral corner parts, and a front wall; wherein the front wall is joined to the back wall forming an open top; and
affixing at least one wear monitor the elevator bucket, wherein the wear monitor transmits information using electromagnetic fields.

15. The method of claim 14, further comprising:
forming a wear band, wherein the wear band is made of an abrasion resistant material; and
affixing the wear band to the lip of the bucket part, wherein the wear band extends entirely across a top portion of the front wall, arcuate corner parts, and extends across a portion of opposed sidewalls extending from the front wall towards the back wall.

16. The method of claim 15, wherein the affixing is embedding at least one wear monitor into the elevator bucket.

17. The method of claim 14, wherein the at least one wear monitor is embedded in the lip or the wear band of the elevator bucket.

18. The method of claim 16, further comprising removably affixing the wear band to the elevator bucket with fasteners, adhesives, tongue and groove system, or a combination thereof.

19. The method of claim 15, wherein the attaching the wear band to the elevator bucket comprises overmolding the wear band onto the lip of the elevator bucket.

20. The method of claim 16, further comprising embedding at least two wear monitors into the elevator bucket.

21. A method for monitoring belt stretch or belt stretch of the material conveyor system using the wear monitoring system of claim 1 comprising:
recording a first time stamp when a first wear monitor affixed to a first elevator bucket passes a monitor reader;
recording a second time stamp when a second wear monitor affixed to a second elevator bucket passes the monitor reader;
determining a length of time between the recording the first time stamp and the recording the second time stamp;
comparing the length of time between the recording the first time stamp and the recording the second time stamp to a prerecorded time differential; and
generating an alert on a computer or mobile device if the length of time between the recording the first time stamp and the recording the second time stamp is outside the prerecorded preferred time differential.

22. A method for monitoring bucket detachment from of the material conveyor system utilizing the wear monitor system of claim 1 comprising:
performing a first reading at least wear monitor affixed to the elevator bucket at a monitor reader, wherein the at least one wear monitor is associated with information about the elevator bucket;
transmitting the first reading to a computer or mobile device;
storing the first reading for a period of time;
performing a second reading of the at least wear monitor affixed to the elevator bucket at a monitor reader;
transmitting the second reading to the computer or mobile device comparing the stored first reading to the second reading; and
generating an alert on a computer or mobile device if the second reading is not transmitted.

23. A method for monitoring belt misalignment in of the material conveyor system utilizing the wear monitor system of claim 1 comprising:
performing a first reading at least wear monitor affixed to a top of at least one side the elevator bucket at a monitor reader, wherein the at least one wear monitor is associated with information about the elevator bucket;
transmitting the first reading to a computer or mobile device;
storing the first reading for a period of time;
performing a second reading of the at least wear monitor affixed to the top of at least one side of the elevator bucket at the monitor reader;
transmitting the second reading to the computer or mobile device comparing the stored first reading to the second reading; and
generating an alert on a computer or mobile device if the second reading is not transmitted.
